(19) United States
(12) Patent Application Publication
(10) Pub. No.: US 2026/0194722 A1
(43) Pub. Date: Jul. 9, 2026

(54) ASSEMBLY STRUCTURE FOR OPTICAL INTERFACE OF OPTICAL TRANSCEIVER MODULE AND ASSEMBLY METHOD FOR OPTICAL INTERFACE OF OPTICAL TRANSCEIVER MODULE

(71) Applicant: ACCELIGHT TECHNOLOGIES (WUHAN) CO., LTD., Wuhan (CN)

(72) Inventors: Gong-En GU, Wuhan (CN); Michael Xiaoyan WEI, Wuhan (CN); William STERLING, Wuhan (CN); Meirong ZHANG, Wuhan (CN)

(73) Assignee: ACCELIGHT TECHNOLOGIES (WUHAN) CO., LTD., Wuhan (CN)

(21) Appl. No.: 19/535,152

(22) Filed: Feb. 10, 2026

Related U.S. Application Data
(63) Continuation of application No. PCT/CN2025/147166, filed on Dec. 30, 2025.

(30) Foreign Application Priority Data
Jan. 3, 2025 (CN) 202510006996.5

(51) Int. Cl. G02B 6/42

(52) U.S. Cl. CPC G02B 6/4219

(57) ABSTRACT

An assembly structure for an optical interface of an optical transceiver module is configured to adjust a spacing between an end face of a metal member and an end face of a ceramic ferrule to a preset distance, and includes: a universal base; a metal member limiting block arranged on the universal base, coaxially arranged with the universal base and configured to position the metal member; and an elastic plunger unit configured to adjust the spacing between the end face of the metal member and the end face of ceramic ferrule to the preset distance, a plunger of the elastic plunger unit being always in contact with the end face of the ceramic ferrule. By adjusting the axial position of the plunger, the assembly structure can adapt to different requirements for a planar depth between the ceramic ferrule and the metal member of optical interfaces of different optical transceiver modules.

### CROSS-REFERENCE TO RELATED APPLICATIONS

This application is a continuation of International Application No. PCT/CN2025/147166, filed on December 30, 2025, which claims priority to Chinese Patent Application No. 202510006996.5, filed on January 3, 2025. The disclosures of the aforementioned applications are hereby incorporated by reference in their entireties.

### TECHNICAL FIELD

The present disclosure relates to the field of optical transceiver module technologies, and in particular, to an assembly structure for an optical interface of an optical transceiver module and an assembly method for the optical interface of the optical transceiver module.

### BACKGROUND

With the advent of the digital era, the internet industry has shown a vigorous development trend, which has directly led to a continuous increase in demand for network communication equipment. As an important component of network communication equipment, an optical transceiver module is also constantly innovating and developing to meet the growing market demand. At the same time, the rapid rise of new-generation information technologies such as cloud computing, artificial intelligence, and big data has significantly increased the demand for computing power, thereby accelerating the construction speed of cloud computing infrastructure. This trend has led to growing demand for high-speed optical transceiver modules such as 200 G, 400 G, 800 G, and even 1.6 T.

Currently, the optical interface of an optical transceiver module serves as a docking window for the optical transceiver module, and therefore, the demand for diversity of optical interfaces of optical transceiver modules has also increased significantly. However, in existing manufacturing processes, each optical interface of an optical transceiver module requiresits own customized assembly structure, leading to issues such as increased production costs and extended delivery cycles.

### SUMMARY

Technical problems to be solved by the present disclosure are to provide an assembly structure for an optical interface of an optical transceiver module and an assembly method for the optical interface of the optical transceiver module, to address technical deficiencies in the related art. By adjusting the axial position of the plunger, the assembly structure can adapt to different requirements for a planar depth between a ceramic ferrule and a metal member of optical interfaces of different optical transceiver modules.

The technical solutions adopted by the present disclosure to solve the aforementioned technical problems are as follows.

The present disclosure discloses an assembly structure for an optical interface of an optical transceiver module, which is configured to adjust a spacing between an end face of a metal member of the optical interface of the optical transceiver module and an end face of a ceramic ferrule of the optical interface of the optical transceiver module to a preset distance. The assembly structure includes: a universal base provided with a first relief hole arranged along a central axis of the universal base for a fiber to pass through and a relief slot for avoiding a capillary tube; a metal member limiting block arranged on the universal base, coaxially arranged with the universal base and configured to position the metal member; and an elastic plunger unit configured to adjust the spacing between the end face of the metal member and the end face of the ceramic ferrule to the preset distance, a plunger of the elastic plunger unit being in contact with the end face of the ceramic ferrule.

In a preferred embodiment of the present disclosure, the elastic plunger unit includes: a limiting block, a press rod limiting block, a plunger fixture, a spring limiting fixture, the plunger and a spring, where the limiting block and the press rod limiting block are coaxially arranged; the plunger fixture is connected between the limiting block and the press rod limiting block, the plunger fixture is coaxially arranged with both the limiting block and the press rod limiting block, and the plunger fixture is displaceable along an axial direction of both the limiting block and the press rod limiting block; the plunger and an adjustment assembly are mounted within the plunger fixture, the plunger is coaxially arranged with the plunger fixture, and the adjustment assembly is configured to adjust an axial position of the plunger; the spring limiting fixture is connected to an outer peripheral surface of the plunger fixture in an axially displaceable manner, and the spring limiting fixture is coaxially arranged with the plunger fixture; and the outer peripheral surface of plunger fixture is sleeved with the spring, and the spring remains in contact with both the spring limiting fixture and the press rod limiting block.

In a preferred embodiment of the present disclosure, the spring limiting fixture is provided with a plurality of fasteners extending along a radial direction of the spring limiting fixture.

In a preferred embodiment of the present disclosure, the adjustment assembly includes: a plunger screw connected to the plunger fixture in a coaxial and threaded manner and a set screw displaceable along a radial direction of the plunger fixture, the set screw is configured to load the plunger radially, and the plunger screw is configured to load the plunger axially.

In a preferred embodiment of the present disclosure, the limiting block is provided with a first positioning installation slot matching with the metal member limiting block, and the press rod limiting block is provided with a guide slot for matching with the plunger fixture.

In a preferred embodiment of the present disclosure, the metal member limiting block is provided with a metal member installation slot coaxially arranged with the universal base, a second relief hole for the fiber to pass through and a radial installation slot for installing the fiber, the metal member installation slot is connected to the second relief hole, and the radial installation slot is connected to both the metal member installation slot and the second relief hole.

In a preferred embodiment of the present disclosure, the universal base is provided with a second positioning installation slot matching with the metal member limiting block.

In a preferred embodiment of the present disclosure, the universal base is provided with a tightening set screw for fixing the metal member limiting block, and the tightening set screw is configured to load the metal member limiting block radially.

In a preferred embodiment of the present disclosure, the universal base is provided with a fiber installation slot connected to both the first relief hole and the relief slot.

The present disclosure also discloses an assembly method for the optical interface of the optical transceiver module. The assembly method is implemented using the aforementioned assembly structure and includes: placing the optical interface of the optical transceiver module, having a metal member equipped with a ceramic ferrule, into a metal member installation slot of a metal member limiting block of an assembly structure; adjusting a plunger screw of the assembly structure to drive a plunger of the assembly structure to move axially, so that a protrusion amount of a front end of the plunger from an inner hole of a plunger fixture of the assembly structure reaches a predetermined protrusion amount; sleeving an elastic plunger unit of the assembly structure onto the metal member limiting block, the elastic plunger unit comprising the plunger with the protrusion amount having been adjusted; and applying an axial pressure to the elastic plunger unit to complete a press-fit fixation, so that the spacing between an end face of the metal member of the optical interface of the optical transceiver module and an end face of the ceramic ferrule of the optical interface of the optical transceiver module is a preset distance.

In a preferred embodiment of the present disclosure, an end of a fiber is inserted into an inner hole of the ceramic ferrule, optical adhesive is used to bond the fiber and the ceramic ferrule, and then the optical adhesive is cured; the ceramic ferrule is grinded to a required angle and a required end-face using a grinder; the ceramic ferrule is sleeved into the metal member, another end of the fiber is inserted into an inner hole of a capillary tube, and optical adhesive is used to bond the fiber and the capillary tube, and then the optical adhesive is cured; the capillary tube is grinded to a required angle and a required end-face using a grinder; the metal member is placed into the metal member installation slot of the metal member limiting block, and a mark on the metal member is adjusted to be parallel to a direction corresponding to an angular high point of the ceramic ferrule; a protruding height of the assembled plunger is measured with a height gauge, the protruding height of the plunger is adjusted to a required size by adjusting the plunger screw, and manual press-fitting is performed; a pressed product is removed, at which point the spacing between the end face of the metal member and the end face of the ceramic ferrule is the preset distance; and an end-face inspection is performed on qualified products to complete the operation.

Beneficial effects produced by the present disclosure are as follows.

The assembly structure for the optical interface of the optical transceiver module in the present disclosure has significant advantages in multiple aspects, effectively addressing several challenges currently faced by the optical transceiver module industry.

Firstly, this assembly structure, through an innovative structural design, particularly ingenious construction of the plunger fixture, achieves functions of adjusting and fine-tuning the axial position of the plunger. This design cleverly resolves the issue of varying planar depths between the ceramic ferrule and the metal member caused by diversity of the optical interface of the optical transceiver module, thereby enabling a single assembly structure to adapt requirements of isolators with different models, thus greatly enhancing production flexibility and efficiency.

Secondly, a modular design of the metal member limiting block in a universal fixture structure is another important innovation. This design allows for quick replacement of the metal member limiting block, thereby effectively addressing diversity of the metal member housing in the optical interface of the optical transceiver module. This not only significantly shortens product delivery cycles but also greatly reduces manufacturing costs by replacing only the metal member limiting block rather than the entire assembly structure. This flexibility enables production lines to quickly respond to changes in market demands, thereby enhancing competitiveness of enterprises.

Additionally, an innovative design of the universal base also brings significant practical improvements. Through clever slotting and a mid-plane design, the issue of difficult placement for an isolator with products at both ends is resolved, and a positioning process between the optical interface of the optical transceiver module and the capillary tube is also optimized. This design not only enhances operational convenience but also improves precision and stability of an assembly process.

The present disclosure further ensures consistency and reliability of assembly quality through standardized operational procedures and precise measurement steps. An adjustable plunger design and a precise measurement process enable more accurate control of the spacing between the metal member and the ceramic ferrule, thereby meeting stringent precision requirements of a high-speed optical transceiver module.

In summary, the assembly structure for the optical interface of the optical transceiver module in the present disclosure effectively addresses diversity challenges faced by the optical transceiver module industry through its multifaceted innovative design. This not only increases production efficiency, reduces manufacturing costs, and shortens delivery cycles, but also optimizes resource utilization and improves product quality. These advantages enable enterprises to better meet growing market demands for a high-speed optical transceiver module such as 200 G, 400 G, 800 G, and even 1.6 T, thereby providing strong support for gaining a competitive edge in the rapidly evolving network communication industry.

### BRIEF DESCRIPTION OF THE DRAWINGS

The following will further illustrate the present disclosure with reference to accompanying drawings and embodiments.

FIG. 1 is a schematic diagram of an elastic plunger unit of an assembly structure for an optical interface of an optical transceiver module in the present disclosure.

FIG. 2 is an assembly diagram of an elastic plunger unit of an assembly structure for an optical interface of an optical transceiver module in the present disclosure.

FIG. 3 is a schematic diagram of a universal base of an assembly structure for an optical interface of an optical transceiver module in the present disclosure.

FIG. 4 is a schematic diagram of an assembly structure for an optical interface of an optical transceiver module in the present disclosure.

FIG. 5 is a schematic diagram of a suspended capillary tube of an assembly structure for an optical interface of an optical transceiver module in the present disclosure.

FIG. 6 is an exploded view of an assembly structure for an optical interface of an optical transceiver module in the present disclosure.

FIG. 7 is a schematic diagram of an optical interface of an optical transceiver module.

FIG. 8 is a flowchart of an assembly method for an optical interface of an optical transceiver module in the present disclosure.

FIG. 9 is a flowchart of an assembly method for an optical interface of an optical transceiver module in specific implementations in the present disclosure.

### DETAILED DESCRIPTION OF THE EMBODIMENTS

To make objectives, technical solutions, and advantages of the present disclosure clearer, the following provides a further detailed description of the present disclosure with reference to accompanying drawings and embodiments. It should be understood that the specific embodiments described herein are only intended to explain the present disclosure and not to limit it.

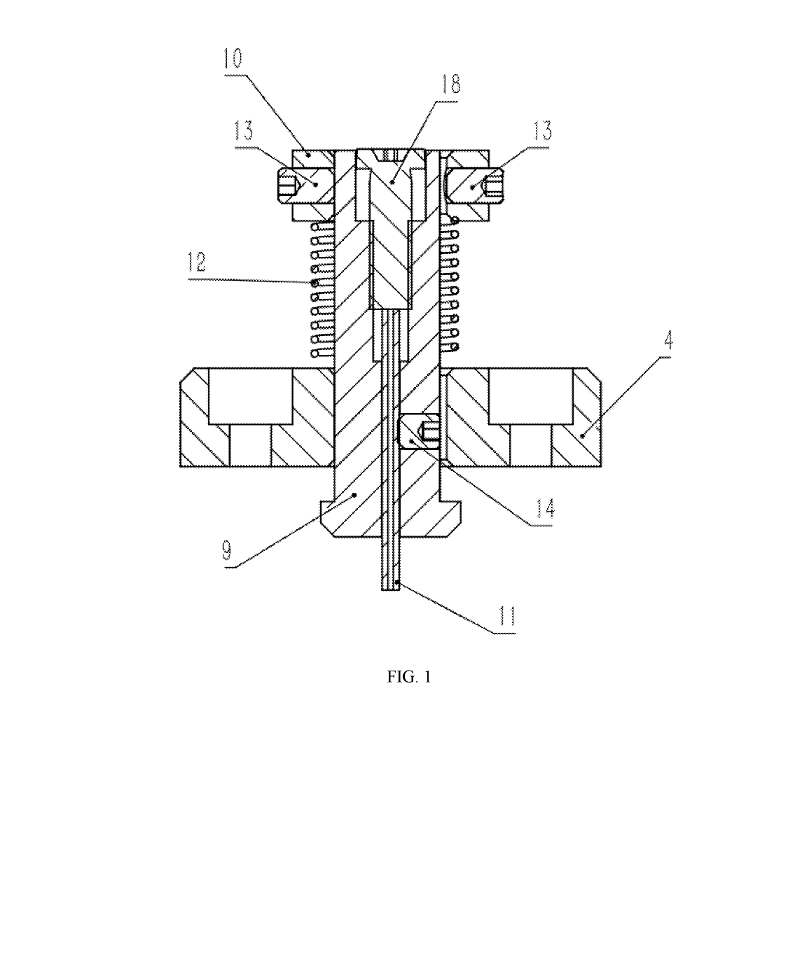

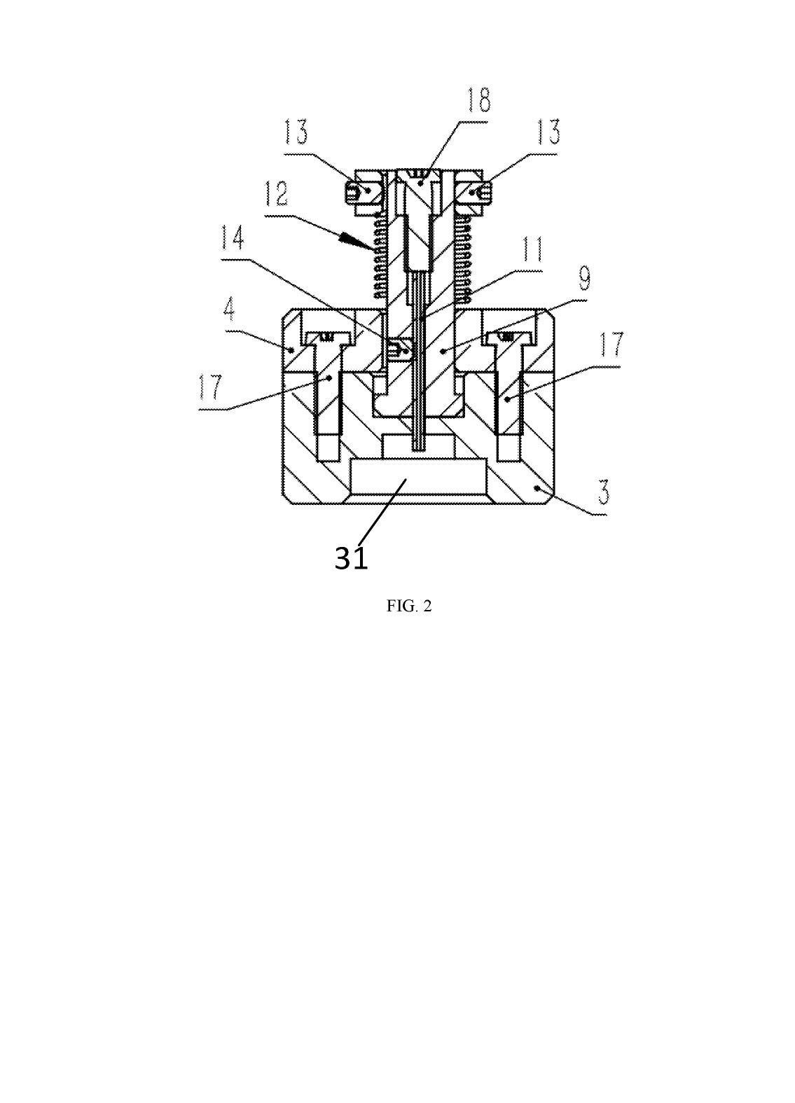

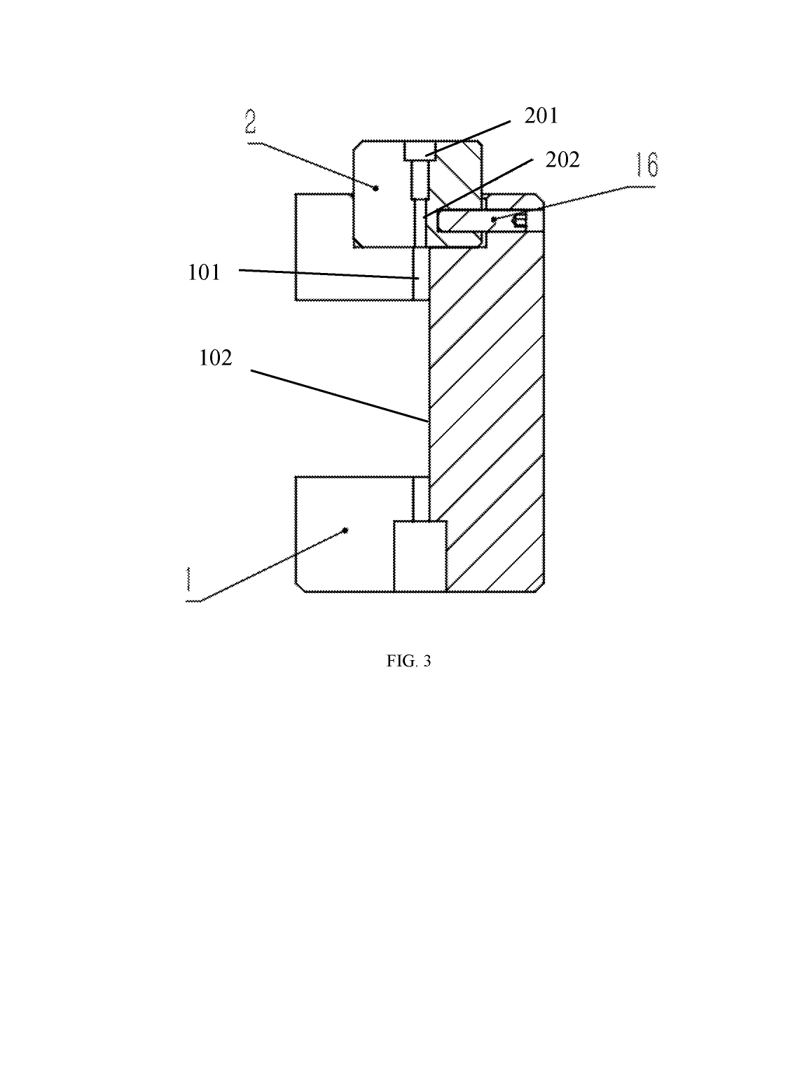

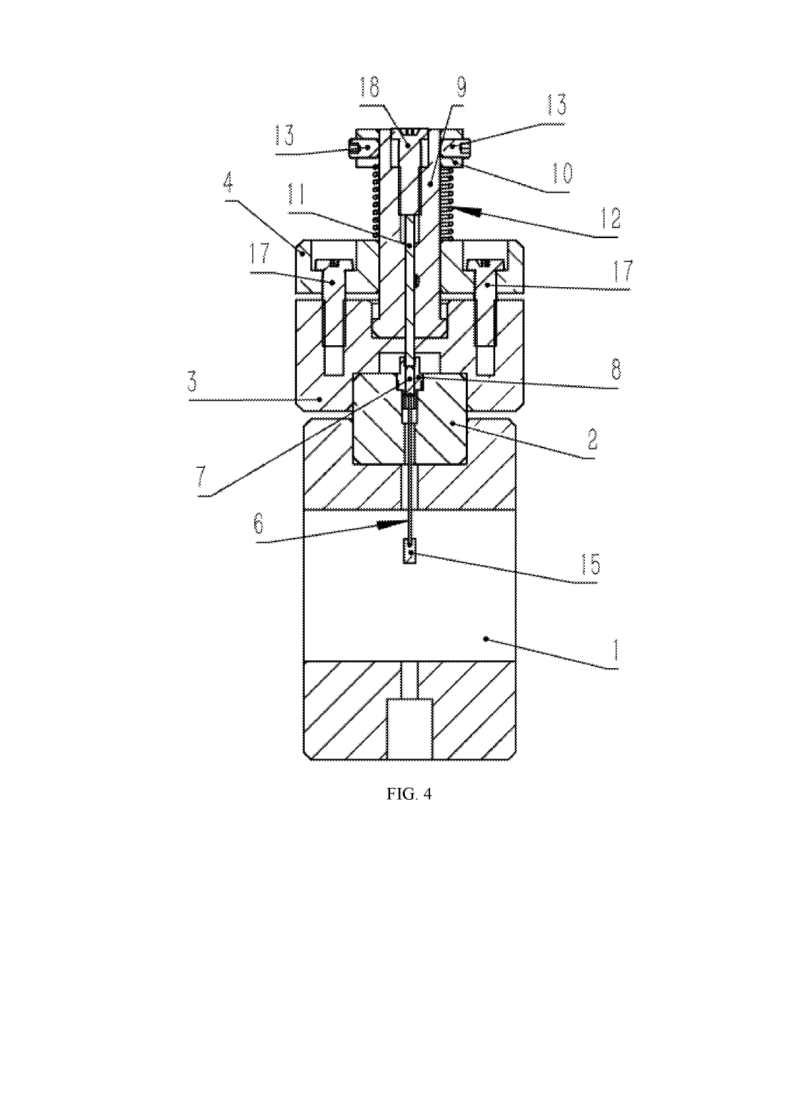

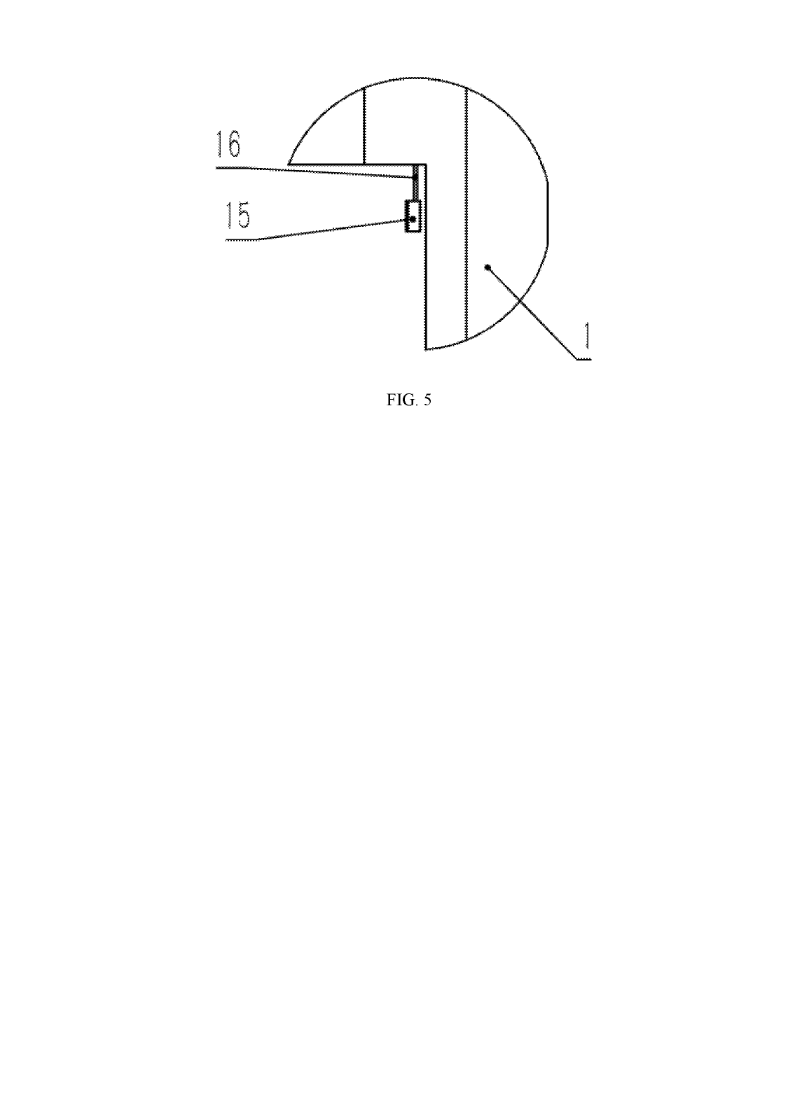

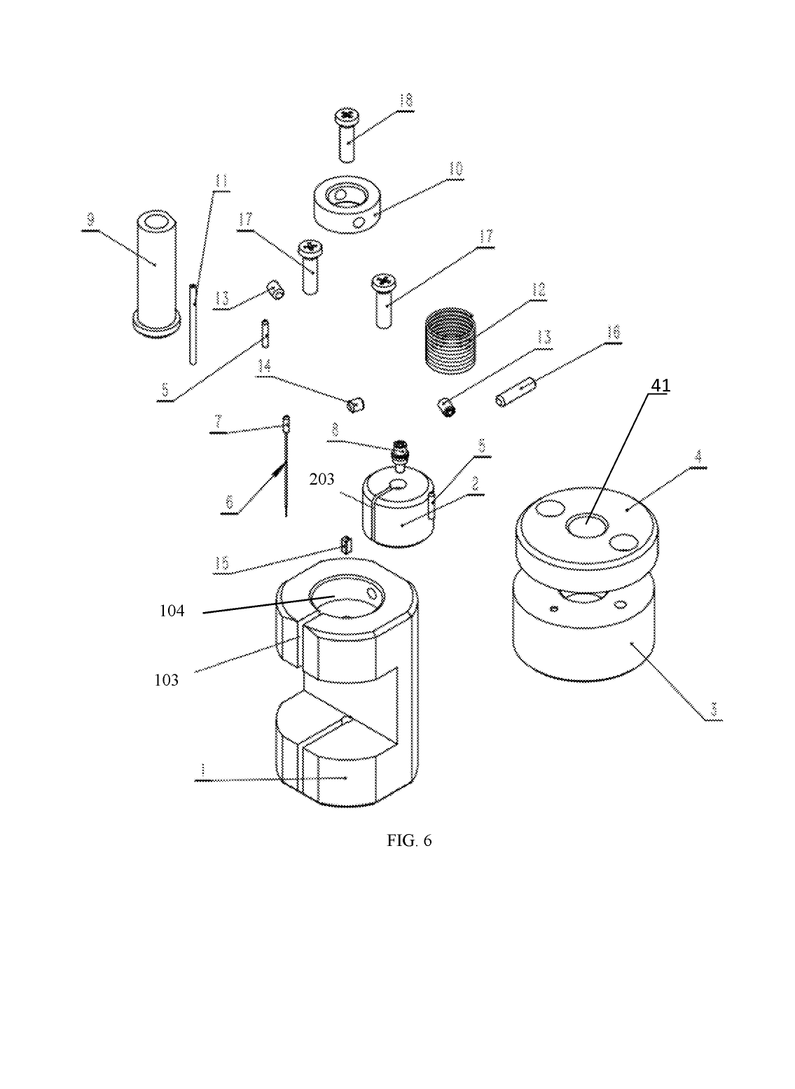

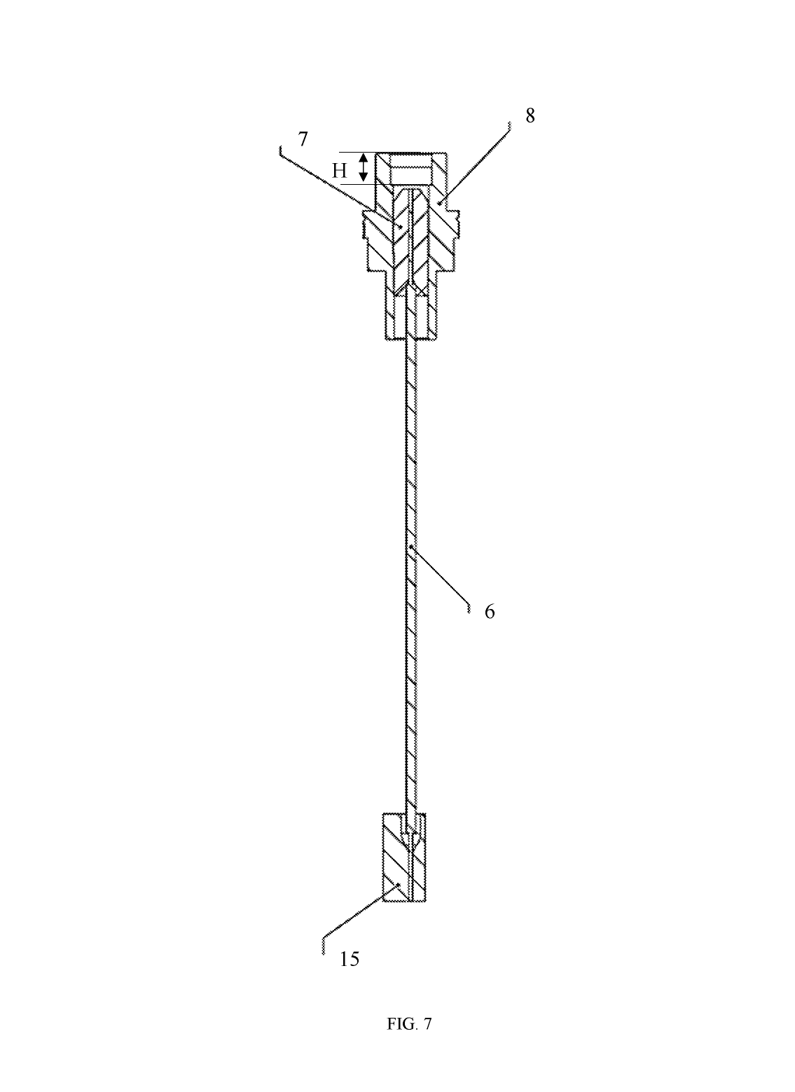

As shown in FIG. 1 to FIG. 7, embodiments of the present disclosure provide an assembly structure for an optical interface of an optical transceiver module, which enables adjustment of the assembly depth of a ceramic ferrule to precisely adjust a spacing H between an end face of a metal member 8 of the optical interface of the optical transceiver module and an end face of a ceramic ferrule 7 of the optical interface of the optical transceiver module to a preset distance. The optical interface of the optical transceiver module includes the metal member 8, the ceramic ferrule 7, a fiber 6, and a capillary tube 15. The fiber 6 is embedded in an inner hole of the ceramic ferrule 7, and the metal member 8 wraps around the ceramic ferrule 7. A shape of the ceramic ferrule 7 is a cylinder, and a distance between the end face of the ceramic ferrule 7 and the end face of the metal member 8 is 1.3 mm ± 0.02 mm. The capillary tube 15 or another connector is connected to a tail end of the fiber 6, an angle of the end face of the ceramic ferrule 7 is 4º, and a direction corresponding to a high point (i.e., a highest point of a slope produced by grinding) of the ceramic ferrule 7 is parallel to a tilt direction (i.e., a chamfer direction) of a chamfered surface of the capillary tube 15. Assembly difficulty of the optical interface of the aforementioned optical transceiver module lies in challenges of timely adjusting the spacing H between the end face of metal member 8 and the end face of ceramic ferrule 7 to the preset distance as needed. The core components of the assembly structure include a universal base 1, a metal member limiting block 2, and an elastic plunger unit.

The universal base 1 serves as a foundational support structure for the entire assembly structure, and the universal base 1 is made of a high-strength alloy material to ensure overall stability and durability. The universal base 1 adopts a cylindrical structure, with a screw hole at a bottom of the universal base 1 for easy installation and fixation of the universal base 1 with other equipment. A first relief hole 101 is provided as an axial through hole in the universal base 1 for the fiber 6 to pass through. A relief slot 102 is provided adjacent to the first relief hole 101. The relief slot 102 is a square slot, the relief slot 102 is used to avoid the capillary tube 15, and the relief slot 102 may also be used to determine an installation direction of the capillary tube 15. Further, the relief slot 102 features a plane that enables 90º angular positioning and accommodates bending of the excessively long fiber 6 without compromising perpendicularity and stability between the metal member 8 and the ceramic ferrule 7 at the apex. This design ensures smooth installation between the fiber 6 and the capillary tube 15 without compromising stability of an overall structure.

On an upper surface of the universal base 1, a cylindrical second positioning installation slot 104 is machined, which precisely matches with the metal member limiting block 2 to ensure accurate positioning of the metal member limiting block 2 during installation. To further enhance fixation stability of the metal member limiting block 2, three tightening set screws 16 are arranged on a side surface of the universal base 1, firmly securing the metal member limiting block 2 through radial loading.

The metal member limiting block 2 is made of a mold steel material processed by high precision, and is provided with a metal member installation slot 201 coaxial with the universal base 1. The metal member installation slot 201 precisely matches the metal member 8 of the optical interface of the optical transceiver module with a common specification. At a center of a bottom of the metal member installation slot 201, there is a second relief hole 202 with a diameter greater than the fiber 6. The second relief hole 202 aligns precisely with the first relief hole 101 of the universal base 1, thereby ensuring smooth passage of the fiber 6. Additionally, a radial installation slot 203 is provided on a side surface of the metal member limiting block 2. The radial installation slot 203 is used for lateral installation of the fiber 6 (i.e., the optical interface of the optical transceiver module may be inserted from the side before press-fitting), and the radial installation slot 203 interconnects with the metal member installation slot 201 and the second relief hole 202, forming a complete fiber installation channel.

The elastic plunger unit is a core component of this assembly structure, responsible for precisely adjusting the spacing H between the metal member 8 and the ceramic ferrule 7 to the preset distance. The elastic plunger unit includes components such as a limiting block 3, a press rod limiting block 4, a plunger fixture 9, a spring limiting fixture 10, a plunger 11, and a spring 12. The limiting block 3 and the press rod limiting block 4 are made of a high-strength mold steel material and are coaxially arranged, and the limiting block 3 and the press rod limiting block 4 are connected at their centers by the plunger fixture 9. The plunger fixture 9 is made of a precision-machined mold steel material and is freely movable in an axial direction, and an interior of the plunger fixture 9 features a central hole for installing the plunger 11.

An outer peripheral surface of the plunger fixture 9 is provided with the spring limiting fixture 10, which is axially movable and is made of a high-strength aluminum alloy material. Three fasteners 13, using hex socket screws with M2 specifications, are evenly distributed on an outer periphery of the spring limiting fixture 10 for precise adjustment of a position of the spring limiting fixture 10. The outer peripheral surface of the plunger fixture 9 is also provided with the spring 12 made of highly elastic stainless steel, i.e., the spring 12 made of highly elastic stainless steel is sleeved on an exterior of the plunger fixture 9. The spring 12 made of stainless steel may maintain an appropriate pressure at all times during an adjustment process.

The plunger 11 has an inner hole that is coaxial with the plunger fixture 9 and extends axially through the plunger 11, and thus the plunger 11 is circular tubular. An outer diameter of the plunger 11 is 1.29 ± 0.01 mm, an inner diameter of the plunger 11 is 0.4 mm, and the inner diameter of the plunger 11 is a diameter of the inner hole. The circular tubular plunger 11 solves the problem of damaging an end face of the fiber 6 during a press-fit process. Further, the plunger 11 is preferably made of tungsten steel.

The plunger11 is inserted into an inner hole (i.e., a central hole) of the plunger fixture 9, a front end of the plunger 11 protrudes from the inner hole of the plunger fixture 9, and a rear end of the plunger 11 is buttressed by a plunger screw 18, thereby ensuring that the plunger 11 is prevented from displacing under load once a length of the plunger 11 is adjusted. The plunger 11 and the plunger fixture 9 are locked together from the side by a set screw 14, thereby ensuring that the plunger 11 is prevented from falling out when suspended. The plunger fixture 9 is first sleeved into the press rod limiting block 4, and the plunger fixture 9 is then sleeved into the spring 12 and the spring limiting fixture 10. The spring limiting fixture 10 is located at an end of the plunger fixture 9 where the spring 12 is installed, and is configured to restrict the spring 12. The spring limiting fixture 10 is secured from both sides with the fastener 13, so that the spring 12 is maintained in a compressed state at all time. When the press-fitting is not performed, the plunger 11 remains in a suspended state.

The adjustment assembly is a key to achieving precise adjustment, including the plunger screw 18 and the set screw 14. The plunger screw 18 adopts an M3 specification and is connected to the plunger fixture 9 in a coaxial and threaded manner. Rotation of the plunger screw 18 allows for precise axial adjustment of the plunger 11, achieving 0.5 mm axial displacement per revolution. The set screw 14, with an M2 specification, is installed on a side surface of the plunger fixture 9 and is radially movable to apply a radial force to the plunger 11, thereby ensuring the plunger 11 remains stable during adjustment.

The limiting block 3 features a cylindrical structure, with two screw holes and two precision positioning pin holes on an upper end of the limiting block 3. A circular slot on the upper end of the limiting block 3 matches with a front end of the plunger fixture 9 in a nesting manner. The limiting block 3 and the press rod limiting block 4 are positioned by the positioning pin holes of the limiting block 3 and a ceramic positioning pin 5, thereby achieving structural limit. The limiting block 3 and the press rod limiting block 4 are then fastened together from the top with a screw 17. This design ensures strictly vertical movement, constraint at both upper and lower limits, and a 5 mm travel space for the plunger fixture 9 during vertical movement of the plunger 11.

A bottom of the limiting block 3 is provided with a first positioning installation slot 31, which matches the metal member limiting block 2, and the first positioning installation slot 31 can ensure precise alignment between the limiting block 3 and the metal member limiting block 2. At a center of the press rod limiting block 4, there is a guide slot 41 with a diameter of 5 mm, and the guide slot 41 is used to precisely match with the plunger fixture 9, thereby ensuring coaxiality of the entire elastic plunger unit.

During actual use, an operator first places the metal member 8 into the metal member installation slot 201 of the metal member limiting block 2, then adjusts an orientation of the metal member 8 so that the mark on the metal member 8 is parallel to the direction corresponding to the angular high point (i.e., a highest point of a slope produced by grinding) of the ceramic ferrule 7. Next, a height of the front end of the plunger 11 protruding from the inner hole of the plunger fixture 9 is adjusted by adjusting the plunger screw 18 until a desired dimension is achieved. During this process, the spring 12 maintains an appropriate pressure at all times, thereby keeping the plunger 11 in contact with the end face of the ceramic ferrule 7. Finally, the operator may verify precision of adjustment by measuring the preset distance between the end face of the metal member 8 and the end face of the ceramic ferrule 7.

The embodiments not only adapt to optical interfaces of optical transceiver modules with different specifications but also enable rapid and precise adjustment, thereby significantly improving production efficiency and product quality.

Additionally, building upon core functionality of the above embodiments, embodiments of the present disclosure may further incorporate certain structural optimizations and functional enhancements to the assembly structure to meet broader application scenarios and higher precision requirements.

The material of the universal base 1 is selected from a precision mold steel material, which offers higher strength and better machining precision compared to an ordinary alloy material, and the universal base 1 is compact and lightweight for easy operation and handling.

On the upper surface of the universal base 1, a bottom of the second positioning installation slot 104 may adopt a V-shaped design. This improvement may provide more precise positioning and more stable installation. A quantity of the tightening set screws 16 is increased to four, and their specifications are upgraded to M4; and the tightening set screws 16 feature a special anti-loosening design to ensure a stable fixing effect is maintained even after prolonged use.

The material of the metal member limiting block 2 is upgraded to a precision mold steel material, enhancing wear resistance and precision stability. The metal member installation slot 201 is designed to be adjustable through the use of a set of precision shims, thereby accommodating the metal member 8 of different specifications with diameters ranging from 9 mm to 11 mm. The second relief hole 202, which also features a variable diameter design, is used in conjunction with the first relief hole 101 of the universal base 1. The radial installation slot 203 also features an optimized design with a curved transition to reduce stress concentration during installation of the fiber 6, thereby improving service life of the fiber 6.

A design of the elastic plunger unit is also significantly improved. The limiting block 3 and the press rod limiting block 4 are made of a precision mold steel material with excellent wear resistance, thereby ensuring long-term precision retention. The material of the plunger fixture 9 is upgraded to a titanium alloy material, and an interior of the plunger fixture 9 adopts a precision ball bearing design, thereby significantly reducing friction during axial movement, and improving adjustment sensitivity and precision.

An internal structure of the plunger fixture 9 is also innovatively designed with addition of a fine-tuning mechanism. This fine-tuning mechanism consists of a set of precision gears that convert rotational motion of the plunger screw 18 into finer linear motion, achieving an axial displacement of 0.001 mm per 0.1-degree rotation, which greatly enhances adjustment precision. The plunger 11 is made of a special tungsten steel material, which offers extremely high hardness and wear resistance, thereby ensuring that its precise dimensions are maintained even after long-term use.

The material of the spring limiting fixture 10 is upgraded to an aerospace-grade aluminum alloy material, which not only improves structural strength and stability, but also maintains lightweight properties. A quantity of the fasteners 13 is increased to four, and the fasteners 13 feature a special anti-loosening thread design to ensure no loosening occurs during frequent adjustment. The spring 12 is made of a stainless-steel material, which offers better elasticity and fatigue strength. A free length of the spring 12 is increased to 35 mm, and a compression length of the spring 12 is reduced to 15 mm. This change provides a larger compression allowance of 20 mm, thereby enabling a wider adjustment range.

The design of the adjustment assembly has also achieved a major breakthrough. The plunger screw 18 features a dual-pitch design, allowing both coarse adjustment and fine adjustment to be completed on a same screw. A pitch of the coarse adjustment is 1 mm/rotation, and a pitch of the fine adjustment is 0.1 mm/rotation, enabling an operator to quickly switch between adjustment modes as needed. The set screw 14 adopts a special eccentric wheel design that enables more precise radial force adjustment through rotation, with a force change of 0.01 N per 1-degree rotation.

The first positioning installation slot 31 of the limiting block 3 features a magnetic adsorption design, which ensures precise positioning and greatly improves efficiency of installation and disassembly. The guide slot 41 of the press rod limiting block 4 adopts a special spiral slot design, and therefore, the press rod limiting block 4 enables the plunger fixture 9 to undergo slight rotational movement during its axial movement, further improving adjustment precision.

During use, this assembly structure not only maintains all the advantages in the above embodiments but also provides higher precision and a wider range of applications. The operator may monitor the preset distance between the metal member 8 and the ceramic ferrule 7 in real-time through a precise digital display. The adjustment precision reaches 0.001 mm. At the same time, the structure is also equipped with an automatic data recording function that automatically saves parameters for each adjustment, thereby facilitating subsequent quality tracking and process optimization.

In addition, embodiments of the present disclosure also provide an assembly method for the optical interface of the optical transceiver module. This assembly method combines precise mechanical operations and strict quality control processes to ensure production of optical interfaces of high-quality optical transceiver modules. The following is a detailed step-by-step description of this assembly method.

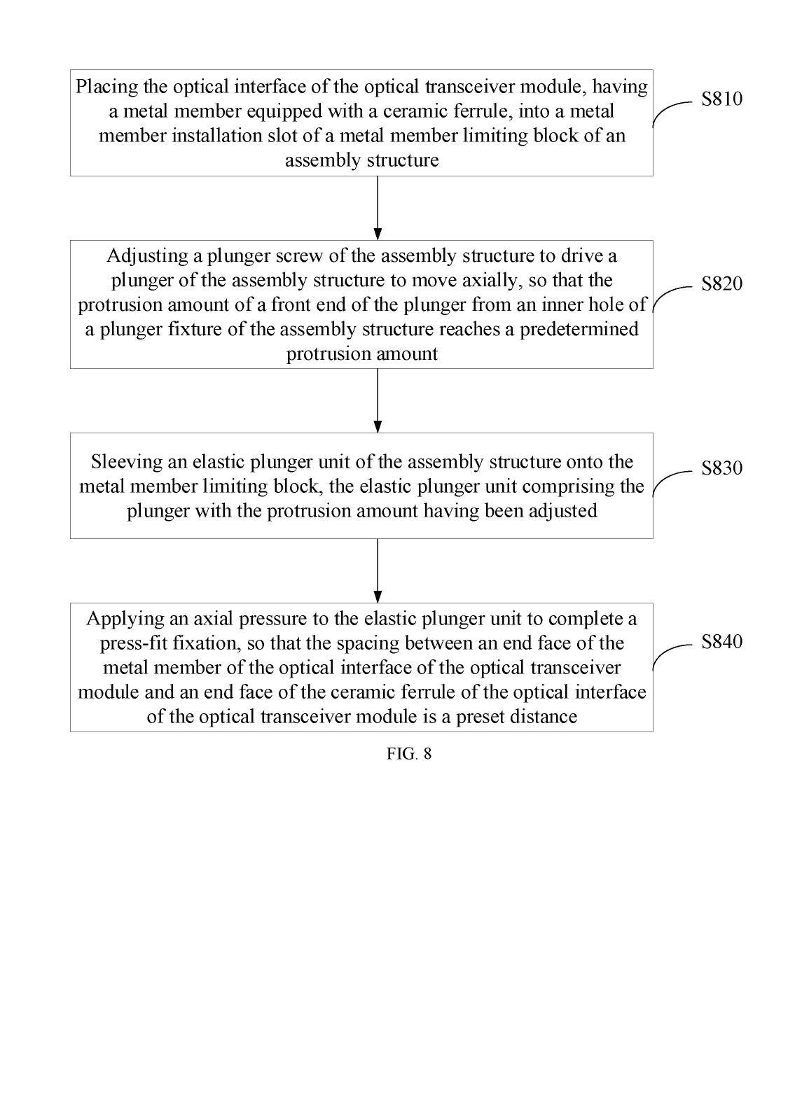

This assembly method is implemented by utilizing the above assembly structure. As shown in FIG. 8, the assembly method includes: S810, placing the optical interface of the optical transceiver module, having a metal member equipped with a ceramic ferrule, into a metal member installation slot of a metal member limiting block of an assembly structure; S820, adjusting a plunger screw of the assembly structure to drive a plunger of the assembly structure to move axially, so that the protrusion amount of a front end of the plunger from an inner hole of a plunger fixture of the assembly structure reaches a predetermined protrusion amount; S830, sleeving an elastic plunger unit of the assembly structure onto the metal member limiting block, the elastic plunger unit comprising the plunger with the protrusion amount having been adjusted; and S840, applying an axial pressure to the elastic plunger unit to complete a press-fit fixation, so that the spacing between an end face of the metal member of the optical interface of the optical transceiver module and an end face of the ceramic ferrule of the optical interface of the optical transceiver module is a preset distance.

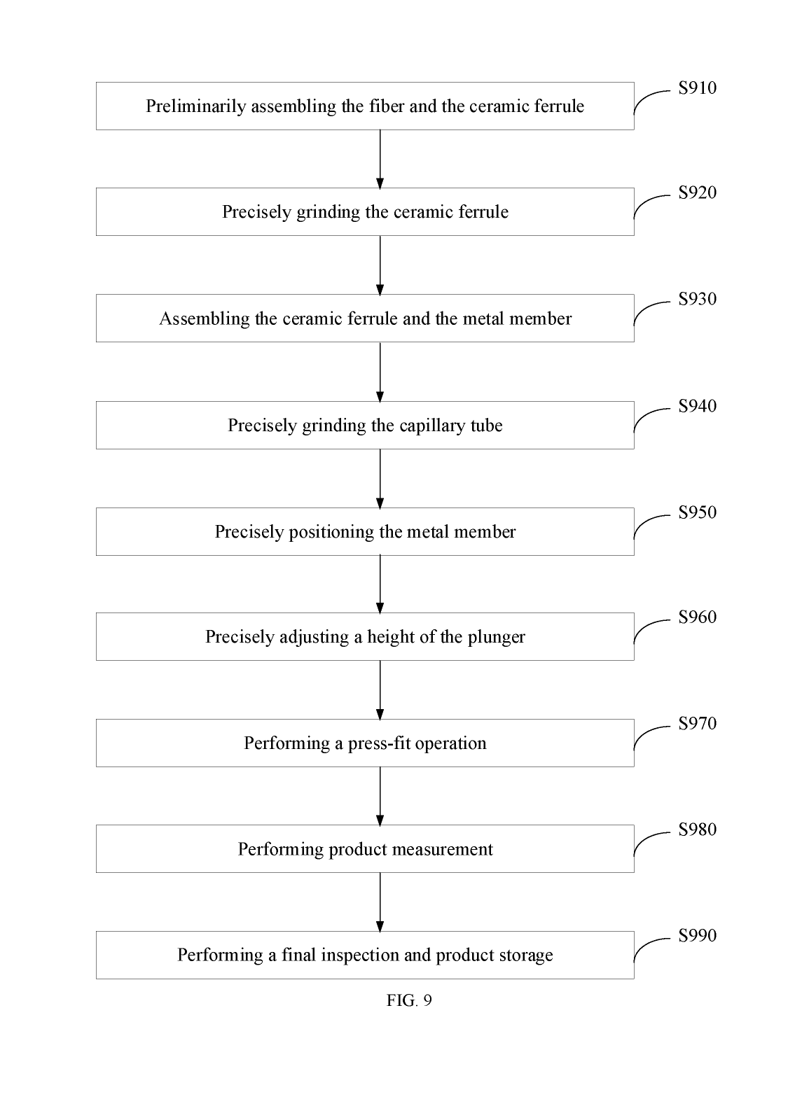

In specific implementations, as shown in FIG. 9, this assembly method may include the following steps.

S910, preliminarily assembling the fiber and the ceramic ferrule.

First, an operator precisely inserts an end of the fiber 6 into an inner hole of the ceramic ferrule 7. This step is performed in a dust-free environment, and the operator should wear dust-free gloves and anti-static clothing. A precision microscope is used to assist this operation, thereby ensuring that the fiber 6 is not damaged during an insertion process. After the fiber 6 is inserted, specialized optical-grade epoxy resin adhesive is used to bond the fiber 6 and the ceramic ferrule 7. The amount of the adhesive is precisely controlled, typically using a precision dispensing machine, with each dispensing amount controlled at around 0.01 ml. After bonding, the assembly is placed into a constant temperature oven for curing. A curing temperature is set at 85°C for a duration of 2 hours to ensure the adhesive is fully cured and reaches optimal strength.

S920, precisely grinding the ceramic ferrule.

After curing, a high-precision fiber end-face grinder is used to grind the ceramic ferrule 7. A grinding process is divided into three stages: a rough grinding stage, a fine grinding stage, and a polishing stage. In the rough grinding stage, a 9 μm diamond grinding disk is used to grind the end face of the ceramic ferrule 7. In the fine grinding stage, a 1 μm diamond grinding disk is used to grind the end face of the ceramic ferrule 7. A grinding angle is typically set to 8º, with a tolerance controlled within ±0.1º. During the grinding process, an online end-face detector is used to monitor end-face quality in real time, including parameters such as a curvature radius of the end-face (usually required to be between 7 mm and 25 mm) or an apex offset of the end-face (required to be less than 50 μm). After the grinding is completed, a clean lint-free cloth is dipped in anhydrous ethanol to clean the end face of the ceramic ferrule 7.

S930, assembling the ceramic ferrule and the metal member.

The grinded ceramic ferrule 7 is carefully sleeved into the metal member 8. This step requires special attention to avoid damaging the ceramic ferrule 7 or the fiber 6 during insertion. A precision alignment microscope is used to ensure a correct position of the ceramic ferrule 7 within the metal member 8. Then, another end of the fiber 6 is threaded into the inner hole of the capillary tube 15. This threading process should be performed slowly to avoid excessive bending of the fiber 6. The same optical adhesive as in S910 is used to bond the fiber 6 and the capillary tube 15, but this time the dispensing amount may be slightly increased to 0.015 ml to ensure sufficient bonding strength. The bonded assembly is placed back into the constant temperature oven for curing, with a same temperature and duration as in S910.

S940, precisely grinding the capillary tube.

The same grinder as in S920 is used to grind the capillary tube 15. A grinding angle is typically set to 8º (perpendicular to a fiber axis), with a tolerance controlled within ±0.1º. During the grinding process, special attention needs to be paid to control a grinding force, thereby avoiding damage to the fiber 6. Similarly, the online end-face detector is used to monitor end-face quality. After grinding, an ultrasonic cleaner is used to clean the end face of the capillary tube 15 in anhydrous ethanol for 3 minutes, thereby removing all grinding residues.

S950, precisely positioning the metal member.

The processed metal member 8 is carefully placed into the metal member installation slot 201 of the metal member limiting block 2. A precision angle gauge is used to adjust a mark on the metal member 8, so that the mark is precisely parallel to a direction corresponding to an angular high point of the ceramic ferrule 7. This step is crucial for subsequent optical performance, and therefore, inspection and adjustment are repeated iteratively until angle deviation is less than 0.1º.

S960, precisely adjusting a height of the plunger.

A precision digital height gauge is used to measure a protruding height of a front end of the assembled plunger 11. After initial measurement, the protruding height of the front end of the plunger 11 is adjusted by slowly rotating the plunger screw 18. The protruding height of the front end of the plunger 11 is re-measured after each adjustment until a design-specified height is achieved. Typically, this height is accurate to 0.01 mm.

S970, performing a press-fit operation.

A limit structure and a movable structure are carefully sleeved onto the metal member limiting block 2, i.e., the entire elastic plunger unit with the adjusted height is sleeved onto the metal member limiting block 2. During this process, contact between the plunger 11 and the end face of the ceramic ferrule 7 should be observed to ensure uniform contact without misalignment. During this process, the operator needs to pay special attention to ensure complete conformity between all components, with no gaps or misalignment. During press-fitting, the operator should wear protective gloves and use a dedicated pressure sensing handle for manual press-fitting. A press-fit force needs to be precisely controlled, typically between 50 N and 100 N, with specific values determined by product specifications. During press-fitting, the operator should apply a pressure slowly and evenly, thereby avoiding sudden impacts.

S980, performing product measurement.

After the press-fitting, the product is carefully removed, and a precision digital depth gauge is used to measure a distance between a top of the ceramic ferrule 7 and a top of the metal member 8. This distance is usually controlled between 0.1 mm and 0.3mm, with specific values determined by product specifications. During measurement, a probe of the gauge should lightly touch a surface of the product to avoid an excessive pressure that could cause measurement errors. Each product should be measured multiple times at different positions (typically 4 points), with an average taken as a final result.

S990, performing a final inspection and product storage.

A final end-face inspection is performed on products that pass measurement. A high-power microscope is used to check for scratches, cracks, or contamination on the end face. Additionally, an insertion loss and return loss tester is used to measure an insertion loss and a return loss of the end-face, with requirements specifying the insertion loss of less than 0.2 dB and the return loss of greater than 60 dB. Products that pass all inspections are considered qualified and are carefully placed in anti-static turnover trays. The turnover trays should be pre-treated to be dust-free and labeled with a product model and a production batch.

Throughout the production process, the operator strictly adheres to clean operating procedures and regularly inspects and calibrates all measuring equipment. After each step is completed, operating parameters and measurement results are recorded in detail on a production record sheet for subsequent quality tracking and process optimization.

By strictly following the above steps, the optical interfaces of the produced optical transceiver modules may have high consistency and reliability, thereby meeting stringent requirements of a high-speed optical communication system. This refined production method not only improves product quality but also enhances production efficiency and reduces scrap rates, thereby lowering overall production costs.

The use of the assembly structure for the optical interface of the optical transceiver module in the present disclosure achieves significant technological breakthroughs in multiple aspects. First, through an innovative design of the tungsten steel tube in the movable structure, the potential issue of end-face damage of the fiber during the press-fit process is effectively resolved. This improvement not only enhances product quality and reliability but also significantly reduces performance degradation and scrap rates caused by the end-face damage, thereby greatly improving overall production efficiency and product yield.

Second, a flexible and adjustable design of the plunger fixture in the movable structure is another key innovation. This design allows for precise adjustment and fine-tuning of an axial position of the tungsten steel tube, thereby cleverly addressing challenges posed by diversity of the optical interface of the optical transceiver module, particularly in cases of varying planar depths between the ceramic ferrule and the metal member. This flexibility enables a single assembly structure to adapt to isolators with different specifications, thereby greatly enhancing versatility of equipment and flexibility of a production line.

A modular split design adopted in the metal member limiting block in a universal fixture structure is another highlight of the present disclosure. This innovation significantly improves adaptability of the structure, thereby enabling the structure to easily handle diversity of the metal member housing in the optical interface of the optical transceiver module. The operator only needs to quickly replace the metal member limiting block without changing the entire assembly structure, which not only significantly shortens product delivery cycles but also greatly reduces manufacturing costs. Since enterprises only need to prepare limiting blocks with different specifications rather than complete structural kits, efficient resource utilization is achieved.

Additionally, slotting and a mid-plane design of the universal base in the universal fixture structure demonstrates ingenuity of the present disclosure. This design cleverly solves two key issues: on one hand, this design addresses the issue of difficult placement for an isolator with products at both ends, thereby significantly improving operational convenience and safety; on the other hand, this design optimizes a positioning process between the capillary tube and the optical interface of the optical transceiver module, thereby enhancing assembly precision and efficiency. These improvements not only boost production efficiency but also reduce operational errors, further ensuring product quality.

The present disclosure achieves comprehensive performance improvements in multiple aspects. The present disclosure significantly improves quality and consistency of the final product through precise control of a press-fit process and an improved structural design. At the same time, an adjustable design enhances flexibility and adaptability of a production line, thereby enabling the production line to quickly adapt to requirements of different models. A modular design and a quick-change mechanism greatly reduce switching time between products with different models, thereby accelerating an overall production speed. By reducing requirements for dedicated structures and improving equipment utilization, the present disclosure effectively lowers production costs. An optimized base design and a flexible adjustment mechanism also improve operational convenience, reduce operational errors, and enhance work efficiency.

It should be understood that a size of sequence numbers of the steps in the above embodiments does not imply an execution order. The execution order of each process should be determined by its function and internal logic, and should not impose any limitation on the implementation process of the embodiments of the present disclosure.

It should be understood that for those of ordinary skill in the art, improvements or modifications may be made based on the above description, and all such improvements and modifications shall fall within the protection scope of the appended claims of the present disclosure.

What is claimed is:

1. An assembly structure for an optical interface of an optical transceiver module, wherein the assembly structure is configured to adjust a spacing between an end face of a metal member of the optical interface of the optical transceiver module and an end face of a ceramic ferrule of the optical interface of the optical transceiver module to a preset distance, and the assembly structure comprises:
a universal base provided with a first relief hole arranged along a central axis of the universal base for a fiber to pass through and a relief slot for avoiding a capillary tube;
a metal member limiting block arranged on the universal base, coaxially arranged with the universal base and configured to position the metal member; and
an elastic plunger unit configured to adjust the spacing between the end face of the metal member and the end face of the ceramic ferrule to the preset distance, a plunger of the elastic plunger unit being in contact with the end face of the ceramic ferrule.

2. The assembly structure according to claim 1, wherein the elastic plunger unit comprises: a limiting block, a press rod limiting block, a plunger fixture, a spring limiting fixture, the plunger and a spring,
wherein the limiting block and the press rod limiting block are coaxially arranged;
the plunger fixture is connected between the limiting block and the press rod limiting block, the plunger fixture is coaxially arranged with both the limiting block and the press rod limiting block, and the plunger fixture is displaceable along an axial direction of both the limiting block and the press rod limiting block;
the plunger and an adjustment assembly are mounted within the plunger fixture, the plunger is coaxially arranged with the plunger fixture, and the adjustment assembly is configured to adjust an axial position of the plunger;
the spring limiting fixture is connected to an outer peripheral surface of the plunger fixture in an axially displaceable manner, and the spring limiting fixture is coaxially arranged with the plunger fixture; and
the outer peripheral surface of the plunger fixture is sleeved with the spring, and the spring remains in contact with both the spring limiting fixture and the press rod limiting block.

3. The assembly structure according to claim 2, wherein the adjustment assembly comprises: a plunger screw connected to the plunger fixture in a coaxial and threaded manner and a set screw displaceable along a radial direction of the plunger fixture, wherein the set screw is configured to load the plunger radially, and the plunger screw is configured to load the plunger axially.

4. The assembly structure according to claim 2, wherein the limiting block is provided with a first positioning installation slot matching with the metal member limiting block, and the press rod limiting block is provided with a guide slot for matching with the plunger fixture.

5. The assembly structure according to claim 2, wherein the spring limiting fixture is provided with a plurality of fasteners extending along a radial direction of the spring limiting fixture.

6. The assembly structure according to claim 5, wherein the limiting block is provided with a first positioning installation slot matching with the metal member limiting block, and the press rod limiting block is provided with a guide slot for matching with the plunger fixture.

7. The assembly structure according to claim 5, wherein the adjustment assembly comprises: a plunger screw connected to the plunger fixture in a coaxial and threaded manner and a set screw displaceable along a radial direction of the plunger fixture, wherein the set screw is configured to load the plunger radially, and the plunger screw is configured to load the plunger axially.

8. The assembly structure according to claim 7, wherein the limiting block is provided with a first positioning installation slot matching with the metal member limiting block, and the press rod limiting block is provided with a guide slot for matching with the plunger fixture.

9. The assembly structure according to claim 2, wherein the metal member limiting block is provided with a metal member installation slot coaxially arranged with the universal base, a second relief hole for the fiber to pass through and a radial installation slot for installing the fiber, wherein the metal member installation slot is connected to the second relief hole, and the radial installation slot is connected to both the metal member installation slot and the second relief hole.

10. The assembly structure according to claim 2, wherein the universal base is provided with a second positioning installation slot matching with the metal member limiting block.

11. The assembly structure according to claim 2, wherein the universal base is provided with a tightening set screw for fixing the metal member limiting block, and the tightening set screw is configured to load the metal member limiting block radially.

12. The assembly structure according to claim 2, wherein the universal base is provided with a fiber installation slot connected to both the first relief hole and the relief slot.

13. The assembly structure according to claim 1, wherein the metal member limiting block is provided with a metal member installation slot coaxially arranged with the universal base, a second relief hole for the fiber to pass through and a radial installation slot for installing the fiber, the metal member installation slot is connected to the second relief hole, and the radial installation slot is connected to both the metal member installation slot and the second relief hole.

14. The assembly structure according to claim 1, wherein the universal base is provided with a second positioning installation slot matching with the metal member limiting block.

15. The assembly structure according to claim 1, wherein the universal base is provided with a tightening set screw for fixing the metal member limiting block, and the tightening set screw is configured to load the metal member limiting block radially.

16. The assembly structure according to claim 1, wherein the universal base is provided with a fiber installation slot connected to both the first relief hole and the relief slot.

17. An assembly method for an optical interface of an optical transceiver module, comprising:
placing the optical interface of the optical transceiver module, having a metal member equipped with a ceramic ferrule, into a metal member installation slot of a metal member limiting block of an assembly structure;
adjusting a plunger screw of the assembly structure to drive a plunger of the assembly structure to move axially, so that a protrusion amount of a front end of the plunger from an inner hole of a plunger fixture of the assembly structure reaches a predetermined protrusion amount;
sleeving an elastic plunger unit of the assembly structure onto the metal member limiting block, the elastic plunger unit comprising the plunger with the protrusion amount having been adjusted; and
applying an axial pressure to the elastic plunger unit to complete a press-fit fixation, so that the spacing between an end face of the metal member of the optical interface of the optical transceiver module and an end face of the ceramic ferrule of the optical interface of the optical transceiver module is a preset distance.

18. The assembly method according to claim 17, wherein the elastic plunger unit comprises: a limiting block, a press rod limiting block, the plunger fixture, a spring limiting fixture, the plunger and a spring,
wherein the limiting block and the press rod limiting block are coaxially arranged;
the plunger fixture is connected between the limiting block and the press rod limiting block, the plunger fixture is coaxially arranged with both the limiting block and the press rod limiting block, and the plunger fixture is displaceable along an axial direction of both the limiting block and the press rod limiting block;
the plunger and an adjustment assembly are mounted within the plunger fixture, the plunger is coaxially arranged with the plunger fixture, and the adjustment assembly is configured to adjust an axial position of the plunger;
the spring limiting fixture is connected to an outer peripheral surface of the plunger fixture in an axially displaceable manner, and the spring limiting fixture is coaxially arranged with the plunger fixture; and
the outer peripheral surface of the plunger fixture is sleeved with the spring, and the spring remains in contact with both the spring limiting fixture and the press rod limiting block.

19. The assembly method according to claim 18, wherein the spring limiting fixture is provided with a plurality of fasteners extending along a radial direction of the spring limiting fixture.

20. The assembly method according to claim 18, wherein the adjustment assembly comprises: a plunger screw connected to the plunger fixture in a coaxial and threaded manner and a set screw displaceable along a radial direction of the plunger fixture, wherein the set screw is configured to load the plunger radially, and the plunger screw is configured to load the plunger axially.
